(19) United States
(12) Patent Application Publication
(10) Pub. No.: US 2015/0047241 A1
(43) Pub. Date: Feb. 19, 2015

(54) Price Channel Marketing Expander System and Device

(71) Applicant: Larry A. Salani, Palatine, IL (US)

(72) Inventor: Larry A. Salani, Palatine, IL (US)

(21) Appl. No.: 14/326,100

(22) Filed: Jul. 8, 2014

Related U.S. Application Data
(60) Provisional application No. 61/867,266, filed on Aug. 19, 2013.

(51) Int. Cl. G09F 3/20; G09F 3/16

(52) U.S. Cl. CPC G09F 3/204; G09F 3/16
USPC 40/661.03

(57) ABSTRACT

A price channel marketing expander device is used with a standard price channel construction for expanding the marketing potential therefor, the price channel marketing expander device includes a primary spine section, at least one, but preferably a plurality of secondary anterior marketing channel constructions, a posterior device-to-channel tuck-in construction, and a posterior securing tab. Each secondary anterior marketing channel construction has an upwardly extending secondary anterior channel section. Each secondary anterior channel section and the primary spine section define a secondary matter-receiving channel. The posterior device-to-channel tuck-in construction has a downwardly extending tuck-in section. The tuck-in section and the primary spine section defining a tertiary matter-receiving channel. The expander construction or device is attachable to a price channel construction via the tuck-in construction and the securing tab prevents upward movement of the expander device relative to the price channel construction when attached thereto.

### PRIOR HISTORY

This application claims the benefit of U.S. Provisional Patent Application No. 61/867,266 filed in the United States Patent and Trademark Office on 19 Aug. 2013.

### BACKGROUND OF THE INVENTION

1. Field of the Invention

The disclosed invention generally relates to a price channel device. More particularly, the present invention relates to a multi-channel, price channel marketing expander device for expanding the marketing potential of state of the art price channel constructions.

2. Descriptions of Prior Art

The prior art in the particularly fields of price channel or labeling signage is fairly well-developed, as is advertising art generally. Some of the more pertinent prior art in these fields of art are briefly described hereinafter. U.S. Pat. No. 5,394,632, issued to Gebka et al., for example, discloses a Price Channel construction. This patent describes an extruded plastic price channel for cooperable fitted placement in a C-channel at the front of a merchandise shelf to provide a mounting for merchandise labelling. The price channel includes a label panel and a leg extending from the back of the label panel. A top edge of the label panel and a free end of the leg snap behind upper and lower lips of the C-channel to retain the price channel in place with the label panel angled to the vertical. The top edge of the label panel has an improved design to enhance its grip in the C-channel. The price channel may also include a transparent co-extruded cover for the front of the label panel to retain non-adhesive labels. See also, U.S. Pat. No. 5,488,793;

U.S. Pat. No. 5,473,833 ('833 patent), issued to Ostrovsky, discloses a Clip-On Price Ticket Channel Cover for Metal Shelving. The '833 patent describes a clip-on label holder and cover for insertion in a price ticket channel member of a shelf. The cover comprises an elongate clear plastic strip, having a clear plastic display panel and an integral clip. A label, such as a data strip, may be inserted between the panel and the channel member. The panel is biased towards the channel, to grip the card between the panel and the channel member. The clip is comprised of a generally hook-shaped member, when seen in cross-section that comprises the lower edge of the cover. The clip defines an interior region, within which a lip of the channel member may be snap-fitted. The clip is provided with first and second shoulders to grip opposing sides of the channel member, to bias the panel towards the channel.

U.S. Pat. No. 5,515,632, issued to Gebka et al., discloses a Lock Window for Price Channels. This patent describes a plastic price channel for attachment along the front edge of a merchandise display shelf to carry labelling pertaining to articles on the shelf has a main body panel and a see-through cover joined to the body panel along its bottom edge so that non-adhesive labels can be fitted between the body panel and the cover. The top edge of the cover can be engaged behind a resilient top lip on the body panel to releasably lock the cover in place and a forwardly extending channel-shaped formation is provided along the top edge of the cover in which the top lip is received. The channel-shaped formation has an upwardly extending outer limb forming a gripping element by which the top edge of the cover can be disengaged from behind the top lip by finger pressure exerted downwardly on the gripping element.

U.S. Pat. No. 6,145,232 ('232 patent), issued to Bevins, discloses a Sign Holder for Shelves with C-Channels. The '232 patent describes a transparent plastic sign holder designed to fit in C-channels of different heights along the front edges of merchandise display shelves. The sign holder is a plastic sheet with a backwardly folded, downwardly depending, first flap integrally connected to the upper edge of the main body panel of the sign holder, and a backwardly folded, upwardly extending second flap integrally connected to the lower edge of the main body panel. A sign can be slidingly engaged behind the transparent main body panel in the bights formed at the connection with the first and second flaps.

The second flap has yet another or third backwardly folded, downwardly depending, flap integrally connected to its upper edge. The first and third flaps each have freely extending lower edge portions and have different heights corresponding to the heights of two different C-channels with which the sign holder is to be used. The lower edge portions of the first flap can either be positioned behind the third flap or between the second flap and the main body panel to expose either the first or third flap for engagement with a C-channel of a corresponding height without the need to invert the sign holder for use with different height C-channels.

U.S. Pat. No. 6,263,603 ('603 patent), issued to Wildrick, discloses a Label Holder for Flat Faced Shelving. The '603 patent describes an extruded plastic label holder for placement on the flat front surface of a product display shelf. The label holder includes a clear front panel joined along its bottom edge with a second panel. The second panel is adhesively mounted on the shelf front surface, either directly or by means of a third panel flexibly joined with the second panel along upper edges of both. A short, rigid fulcrum rib is formed integrally with one of the second or (if employed) third panels, slightly above the bottom edge of the second panel and extending generally at right angles thereto.

When the bottom edge of the label holder is pressed, the second panel flexes about the fulcrum rib, opening a gap at the upper portion of the label holder for placement or removal of paper labels. The use of a third panel helps to isolate the forces applied in flexing the second panel from the adhesive attachment, enabling less aggressive adhesives to be effectively utilized. Additionally, if a third panel is utilized, portions of the first and second panels can safely be allowed to project below the bottom of the shelf, to accommodate thin shelves or tall label holders, because the front and second panels can flex outwardly about the upper edge connection between the second and third panels. Where such downward projection is contemplated, it may be possible to eliminate the fulcrum rib and allow the bottom edge of the shelf to form the fulcrum.

U.S. Pat. No. 6,553,702 ('702 patent), issued to Bacnik, discloses a Holder for an Electronic Price Label. The '702 patent describes an extruded holder for an electronic price label (EPL) comprising a channel member defined by a base wall and first and second spaced-apart sidewalls that project outwardly from opposite ends of the base wall with respective first and second inner faces arranged in opposed facing relation. The base wall and the sidewalls define a C-shaped recess in the channel member. The sidewall inner faces each define a groove that extends parallel to the base wall, and an associated EPL is adapted for receipt in the recess with first and second projections of the EPL respectively positioned in the first and second grooves.

A clip is connected to the channel member and is adapted for releasable connection to a wide variety of different retail shelf fixtures. The clip is defined by a base member and a back member interconnected to define an L-shaped cross-sectional shape, and the clip is further defined by a connecting arm that has a first end connected to the clip base member and a second end connected to the channel member. The connecting arm and the clip back member define a slot therebetween that receives and retains a projecting edge of an associated retail shelf. In an alternative embodiment, the channel member includes an adhesive mounting portion connected thereto that is adapted for adhesive securement to an associated retail shelf or to an adapter that is, in turn, connected to the retail shelf, a wire basket, or other retail fixture.

U.S. Pat. No. 7,316,089 ('089 patent), issued to Brinkman, discloses a Clip-On Price Channel. The '089 patent describes a clip-on price channel that is designed to clip on to storage room shelving without the use of adhesive tape, nails, screws, etc. The shelf that it is designed to work with is made of wood and has a metal rail attached to the front edge. The price channel has a U-shaped, rear facing flange with opposing fingers at the free-ends that go over the metal rail that is attached to the shelf and grip into grooves between the metal rail and the wood shelf.

U.S. Pat. No. 7,340,855 ('855 patent), issued to Wiltfang et al., discloses a Shelf Sign Holder. The '855 patent describes a sign holder including a main portion, a flange, and an interface hook. The main portion longitudinally extends in a substantially planar manner and defines a top end, a bottom end opposite the top end, a first surface, and a second surface opposite the first surface. The flange is folded back from the bottom end toward the top end and the first surface of the main portion. The flange is biased toward the first surface of the main portion. The interface hook is folded back from the top end toward the second surface and the bottom end of the main portion and is configured to receive a portion of a shelf assembly to couple the sign holder to the shelf assembly. A pocket is defined between the main panel and the flange and is configured to receive a printed medium.

United States Patent Application Publication No. 2003/0217497, authored by Nagel, discloses a Plastic Label Holder with Integral Sign Holder. The Nagel holder is provided with a specifically improved form of auxiliary sign clip along its upper front edge. The label holder is formed of a relatively rigid plastic material, and the sign clip includes a downwardly extending portion overlying the upper front margin of the label holder to accommodate upward insertion of special sign tags. A thin, flexible tongue-like retaining element extends across a lower portion of the sign clip and is adapted to be easily deflected by upward insertion of a paper sign but thereafter lightly grips the sign to hold it in place. A process is also described for the continuous extrusion of the new label holder product, enabling the continuous co-extrusion of the soft, flexible tongue-like retaining element together with the main section of the label holder.

United States Patent Application Publication No. 2005/0081417, authored by Valiulis, discloses Merchandise Labels for Merchandiser Units and Method and Labeling System using Same. This application describes a friction coated label and labeling sheet for use in labeling a label holder of a merchandiser unit that supports merchandise in which the label holder has means for supporting one or more labels without an adhesive bond. The labeling sheet comprises a plurality of friction coated labels removably secured to the release liner. The friction-coated labels include a face stock and a friction coating integrally connected to the face stock. The face stock has printed indicia thereon relating to the merchandise. The friction coating may comprise a weak adhesive that is adapted to inhibit migration of the friction coated labels but is not strong enough to provide a self supporting reliable adhesive bond for retail applications.

### SUMMARY OF THE INVENTION

In distinction from the foregoing prior art citations, the present invention provides a price channel marketing expander device or apparatus usable in combination with a state of the art price channel construction for expanding the marketing potential for the same. In other words, the present invention basically contemplates a price channel marketing expander device and/or system for expanding the marketing potential for a state of the art price channel construction.

To achieve this primary objective, the price channel marketing expander device according to the present invention may thus be used in combination with a primary price channel construction, which primary extruded price channel construction preferably has a fixed transverse cross-sectional channel profile. The fixed transverse cross-sectional channel profile of the price channel construction usable in combination the device according to the present invention preferably comprises certain shelf-attachment means for attaching the extruded price channel construction to a state of the art shelf unit as exemplified by certain double sided adhesive(s).

The price channel construction usable in combination with the device according to the present invention further preferably comprises a downwardly extending posterior channel section, an upwardly extending anterior channel section, and a primary anterior-to-posterior channel section junction site.

The primary posterior and anterior channel sections are preferably spaced from one another via the anterior-to-posterior section junction site thereby forming a primary matter-receiving channel, which primary matter-receiving channel has a primary open upper channel end. Printed marketing and/or pricing information printed upon planar card stock type material(s) and the like is typically placed into the matter-receiving channel of a typical or state of the art price channel construction, which information is typically directed to the products supported by the shelving units.

The price channel marketing expander device according to the present invention basically functions to expand the viewable informational space otherwise provided by a state of the art price channel construction, particularly when the device incorporates a multi-channel construction having two or more anterior price channel constructions associated with the device. To achieve this primary objective, the expander device according to the present invention preferably comprises an extruded expander construction having a fixed transverse cross-sectional expander profile.

The fixed transverse cross-sectional expander profile of the expander construction preferably has or comprises a primary spine section; at least one, but preferably two or more anterior marketing channel constructions; a posterior device-to-channel tuck-in construction; and a posterior securing tab or nipple. The primary spine section extends in a first dimension, and has an upper spine end, a lower spine end, and a spine length intermediate the upper and lower spine ends.

Each anterior marketing channel construction preferably has a channel-to-spine junction site, and an upwardly extending secondary anterior channel section. The upwardly extending secondary anterior channel section(s) and the primary spine section together define a secondary matter-receiving channel, each of which secondary matter-receiving channels have an open upper secondary channel end.

The posterior device-to-channel tuck-in construction preferably has a tuck-to-spine junction site and a downwardly extending tuck-in section. The downwardly extending tuck-in section and the primary spine section together define a tertiary matter-receiving channel, which tertiary matter-receiving channel has an open lower channel end. The tuck-in section preferably has a select tuck-in length selected from a tuck-in length range ranging from 0.25 inches (0.635 cm) to 2.5 inches (6.35 cm).

The posterior securing tab or nipple preferably has a tab-to-spine junction site as and a select tab length, which select tab length preferably extends posteriorly relative to the primary spine section orthogonal thereto in a second dimension. The select tab length of the fixed transverse cross-sectional expander profile is preferably selected from a tab length range, which tab length range preferably ranges from 0.125 inches (0.31750 cm) to 0.625 inches (1.5875 cm).

The extruded expander construction of the device is attachable to the primary extruded price channel construction by simultaneously inserting the downwardly extending tuck-in section into the primary matter-receiving channel and the upwardly extending primary anterior channel section into the tertiary matter-receiving channel. The posterior securing tab extends posteriorly in inferior adjacency to the anterior-to-posterior channel section junction site for preventing upward movement of the extruded expander construction of the device relative to the primary extruded price channel construction.

As indicated, the price channel marketing expander system according to the present invention contemplates that the fixed transverse cross-sectional expander profile will comprise at least one, but preferably a plurality of anterior marketing channel constructions for expanding the viewable plane(s) for positioned marketing/pricing information. The invention, accordingly, could conceivably comprise a single anterior marketing channel construction of relatively larger viewable area as compared to the viewable area otherwise provided by the existing or provided price channel.

Preferably, however, the price channel marketing expander device comprises at least one upper anterior marketing channel construction and a lowermost anterior marketing channel construction. The lowermost anterior marketing channel construction extends from the primary spine section with an arcuate radius of curvature at its corresponding channel-to-spine junction site while each upper anterior marketing channel construction preferably extends from the primary spine section orthogonally in the second dimension at the respective or corresponding channel-to-spine junction site(s). Similarly, the posterior device-to-channel tuck-in construction preferably extends from the upper spine end of the primary spine section orthogonally in the second dimension at the corresponding tuck-to-spine junction site.

The fixed transverse cross-sectional expander profile further preferably comprises an uppermost anterior marketing channel construction and a channel lid section. The channel lid section extends anteriorly from the primary spine section in the second dimension for covering the open upper channel end of the uppermost anterior marketing channel construction. The channel lid section preferably extends orthogonally relative to the primary spine section in the second dimension and is coextensive with the device-to-channel tuck-in construction at the tuck-to-spine junction site.

Other objects of the present invention, as well as particular features, elements, and advantages thereof, will be elucidated or become apparent from, the following brief descriptions and the accompanying drawing figures.

### BRIEF DESCRIPTION OF THE DRAWINGS

Other features and objectives of my invention will become more evident from a consideration of the following brief descriptions of patent drawings:

FIG. 1 is a fragmentary top anterior perspective view of a three-dimensional section of the price channel marketing expander device according to the present invention.

FIG. 2 is an enlarged transverse cross-sectional view of price channel marketing expander device according to the present invention.

FIG. 3 is a fragmentary top perspective diagrammatic type depiction of a PRIOR ART price channel construction attached to a PRIOR ART shelf unit.

FIG. 4 is an enlarged transverse cross-sectional depiction of a PRIOR ART price channel construction attached to a PRIOR ART shelf unit.

FIG. 5 is a first sequential fragmentary top perspective diagrammatic type depiction of the price channel marketing expander device according to the present invention being attached to a PRIOR ART price channel construction.

FIG. 6 is a second sequential fragmentary top perspective diagrammatic type depiction the price channel marketing expander device according to the present invention finally attached to a PRIOR ART price channel construction.

FIG. 7 is a first sequential enlarged transverse cross-sectional type depiction of the price channel marketing expander device according to the present invention being attached to a PRIOR ART price channel construction.

FIG. 8 is a second sequential enlarged transverse cross-sectional type depiction of the price channel marketing expander device according to the present invention finally attached to a PRIOR ART price channel construction.

FIG. 9 is a side-by-side comparative depiction of a leftmost tuck-in section of the price channel marketing expander device according to the present invention shown with a first relatively abbreviated length adjacent a rightmost tuck-in section with a second relatively elongate length.

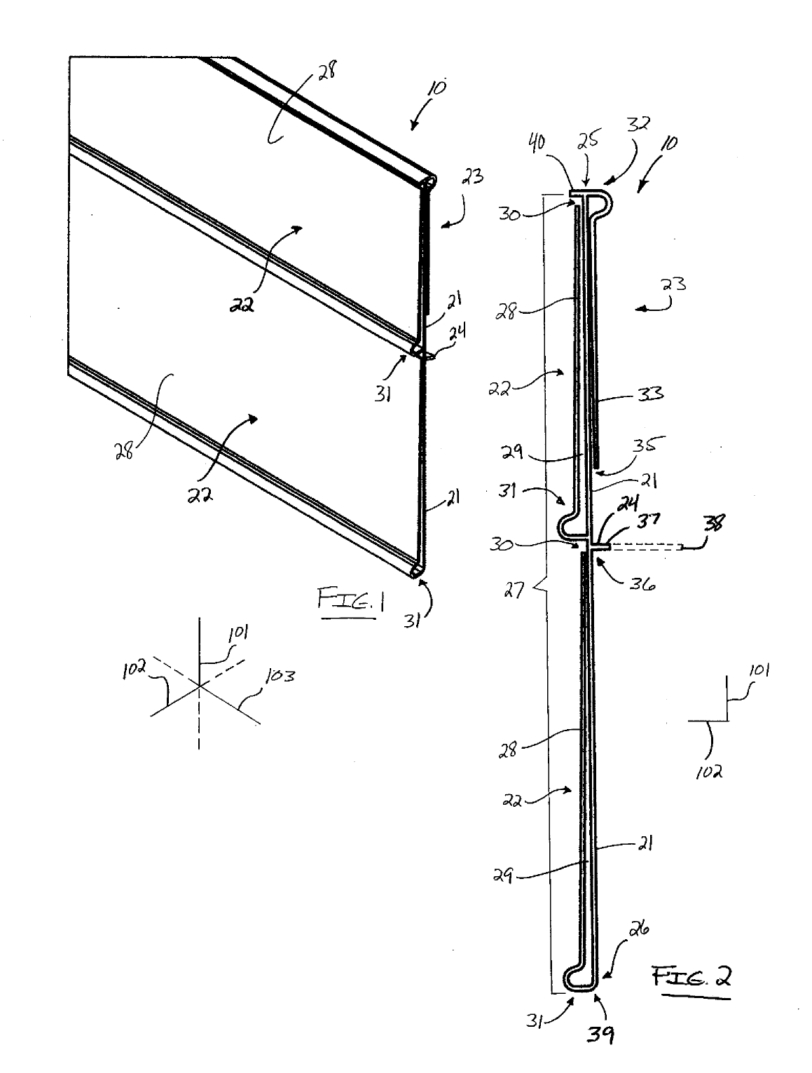

### DETAILED DESCRIPTION OF THE PREFERRED EMBODIMENT

Referring now to the drawings with more specificity, the present invention provides a price channel marketing expander device or apparatus as at 10, which device or apparatus 10 may be viewed systemically when used in combination with a state of the art price channel construction as at 11 for expanding the marketing potential for the same. In other words, the present invention basically contemplates a price channel marketing expander device 10 and/or system for expanding the marketing potential for a state of the art price channel construction 11.

The price channel marketing expander system according to the present invention may thus be said to preferably comprise, in combination, a primary extruded (state of the art) price channel construction 11, which primary extruded price channel construction 11 preferably has or comprises a fixed transverse cross-sectional channel profile as generally depicted in FIG. 4. The fixed transverse cross-sectional channel profile of the price channel construction 11 usable in combination the device 10 according to the present invention preferably comprises certain shelf-attachment means for attaching the extruded price channel construction 11 to a state of the art shelf unit as generically depicted and referenced at 12.

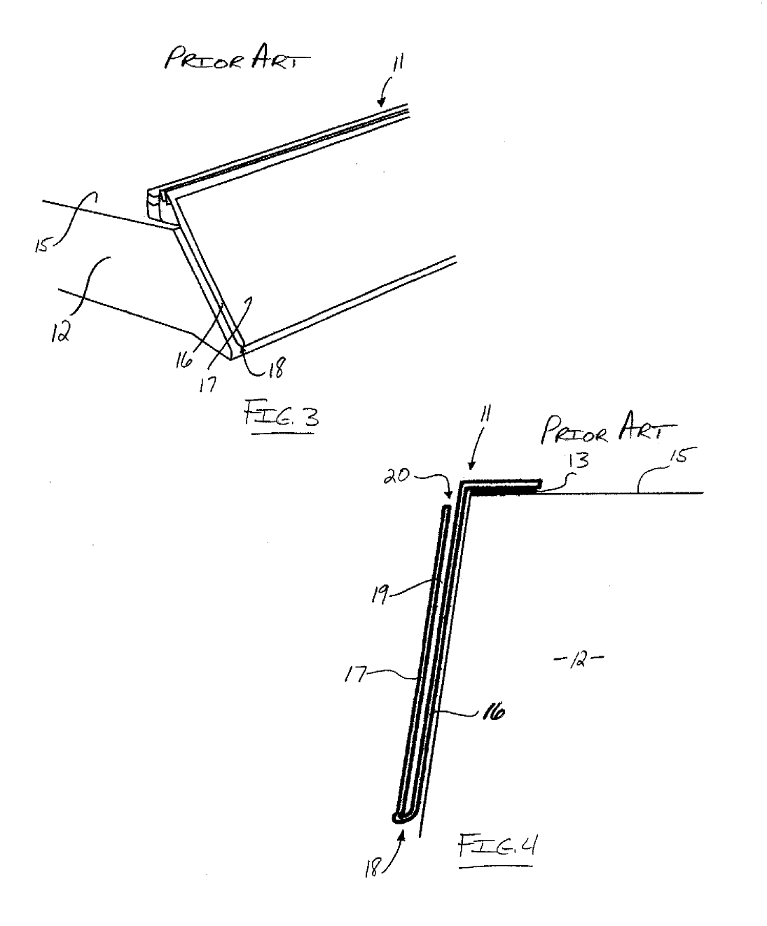

The shelf-attachment means may be preferably exemplified by certain double-sided adhesive construction 13 for adhering the price channel construction 11 to either the top 15 of a shelf unit 12 as depicted in FIGS. 3 and 4 or the bottom of a shelf unit (not specifically illustrated). The price channel construction 11 further preferably comprises a downwardly extending posterior channel section as at 16, an upwardly extending anterior channel section as at 17, and an anterior-to-posterior channel section junction site as at 18.

The posterior and anterior channel sections 16 and 17 are preferably spaced from one another via the anterior-to-posterior section junction site 18 thereby forming a primary matter-receiving channel as at 19, which primary matter-receiving channel 19 has a primary open upper channel end as at 20. Printed marketing and/or pricing information printed upon planar card stock type material(s) and the like is typically placed into the matter-receiving channel 19 of a typical or state of the art price channel construction as depicted in FIGS. 3 and 4, which information is typically directed to the products supported by the shelving units 12.

The price channel marketing expander device 10 according to the present invention basically functions to expand the viewable informational space otherwise provided by a state of the art price channel construction, particularly when the device 10 incorporates a multi-channel construction having two or more anterior price channel constructions 22 associated with the device 10. To achieve this primary objective, the expander device according to the present invention preferably comprises an extruded expander construction (being extruded in a third dimension 103) having a fixed transverse cross-sectional expander profile (extending in first and second dimensions 101 and 102) as generally depicted in FIG. 2.

The fixed transverse cross-sectional expander profile of the expander construction preferably has or comprises a primary spine section as at 21; at least one, but preferably two or more anterior marketing channel constructions as at 22; a posterior device-to-channel tuck-in construction as at 23; and a posterior securing tab or nipple as at 24. The primary spine section 21 extends in a first dimension as at 101, and has an upper spine end 25, a lower spine end 26, and a spine length 27 intermediate the upper and lower spine ends 25 and 26.

Each anterior marketing channel construction 22 preferably has or comprises a channel-to-spine junction site as at 31, and an upwardly extending secondary anterior channel section as at 28. The upwardly extending secondary anterior channel section(s) 28 and the primary spine section 21 together define a secondary matter-receiving channel as at 29, each of which secondary matter-receiving channels have an open upper secondary channel end as at 30.

The posterior device-to-channel tuck-in construction 23 preferably has or comprises a tuck-to-spine junction site as at 32, and a downwardly extending tuck-in section as at 33. The downwardly extending tuck-in section 33 and the primary spine section 21 together define a tertiary matter-receiving channel as at 34, which tertiary matter-receiving channel 34 has an open lower channel end as at 35.

The tuck-in section 33 preferably has a select tuck-in length selected from a tuck-in length range ranging from 0.25 inches (0.635 cm) to 2.5 inches (6.35 cm) as diagrammatically depicted in FIG. 9 wherein the leftmost section 33 represents a tuck-in length on the order of 0.25 inches and the rightmost section 33 represents a select tuck-in length on the order of 2.5 inches, it being understood that the select tuck-in length can be selected from any number of lengths within this range of lengths.

The posterior securing tab or nipple 24 preferably has or comprises a tab-to-spine junction site as at 36, and a select tab length, which select tab length preferably extends posteriorly relative to the primary spine section 21 orthogonal thereto in a second dimension as depicted and referenced at 102. The select tab length of the fixed transverse cross-sectional expander profile is preferably selected from a tab length range, which tab length range preferably ranges from 0.125 inches (0.31750 cm) (as generically depicted in solid lines 37 in FIG. 2) to 0.625 inches (1.5875 cm) (as generically depicted in broken lines 38 in FIG. 2).

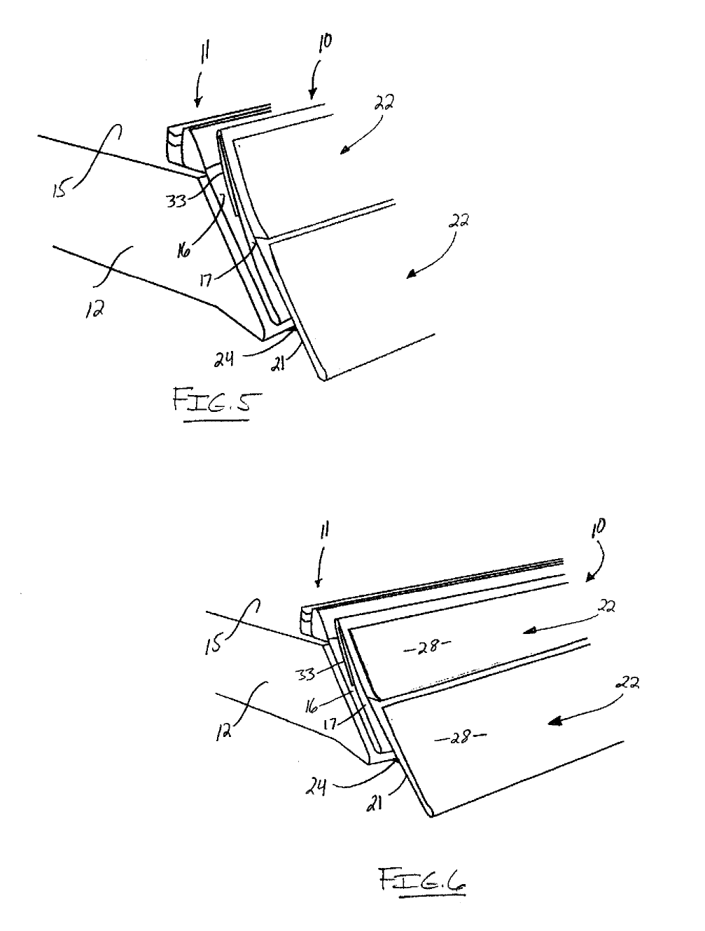

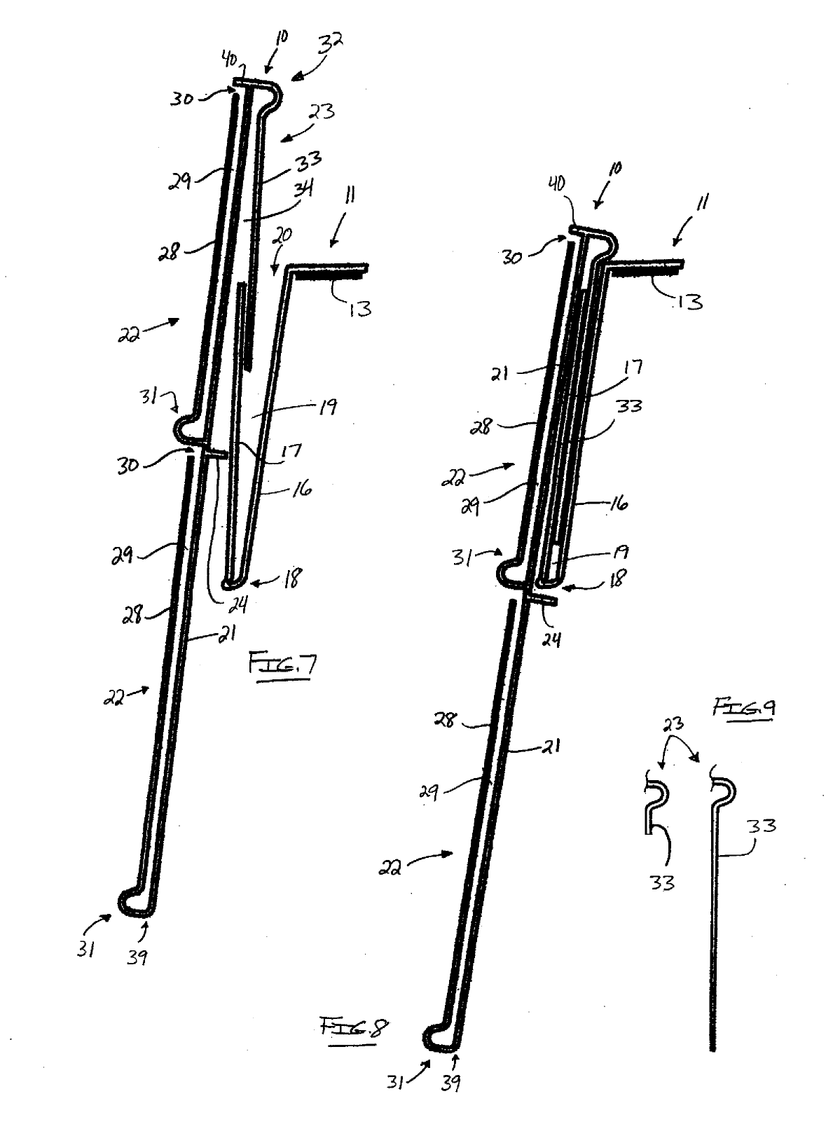

The extruded expander construction of the device 10 is attachable to the primary extruded price channel construction 11 by simultaneously inserting (1) the downwardly extending tuck-in section 33 into the primary matter-receiving channel 19 and (2) the upwardly extending primary anterior channel section 17 into the tertiary matter-receiving channel 34 as comparatively depicted in FIGS. 5-8. The posterior securing tab 24 extends posteriorly in inferior adjacency to the anterior-to-posterior channel section junction site 18 for preventing upward movement of the extruded expander construction of the device 10 relative to the primary extruded price channel construction 11.

As indicated, the price channel marketing expander system according to the present invention contemplates that the fixed transverse cross-sectional expander profile will comprise at least one, but preferably a plurality of anterior marketing channel constructions 22 for expanding the viewable plane(s) for positioned marketing/pricing information. The invention, accordingly, could conceivably comprise a single anterior marketing channel construction of relatively larger viewable area as compared to the viewable area otherwise provided by the existing or provided price channel 11.

Preferably, however, the price channel marketing expander device 10 comprises at least one upper anterior marketing channel construction 22 and a lowermost anterior marketing channel construction 22. The lowermost anterior marketing channel construction as generally depicted in FIGS. 2, 7, and 8 extends from the primary spine section 21 with an arcuate radius of curvature 39 at its corresponding channel-to-spine junction site 31 while each upper anterior marketing channel construction 22 preferably extends from the primary spine section 21 orthogonally in the second dimension 102 at the respective or corresponding channel-to-spine junction site(s) 31. Similarly, the posterior device-to-channel tuck-in construction 23 preferably extends from the upper spine end 25 of the primary spine section 21 orthogonally in the second dimension 102 at the corresponding tuck-to-spine junction site 32.

The fixed transverse cross-sectional expander profile further preferably comprises an uppermost anterior marketing channel construction 22 and a channel lid section as at 40. The channel lid section 40 extends anteriorly from the primary spine section 21 in the second dimension 102 for covering the open upper channel end 30 of the uppermost anterior marketing channel construction 22. The channel lid section 40 preferably extends orthogonally relative to the primary spine section 21 in the second dimension 102 and is coextensive with the device-to-channel tuck-in construction 23 at the tuck-to-spine junction site 32.

While the above descriptions contain much specificity, this specificity should not be construed as limitations on the scope of the invention, but rather as an exemplification of the invention. The basic invention may be said to essentially teach or disclose a price channel marketing expander device for use with a price channel construction for expanding the marketing potential of the price channel construction.

The price channel marketing expander device according to the present invention basically comprise an expander construction having a fixed transverse cross-sectional expander profile. The fixed transverse cross-sectional expander profile may be defined as comprising a primary spine section as at 21, at least one secondary anterior marketing channel construction as at 22, a posterior device-to-channel tuck-in construction as at 23, and a posterior securing tab or nipple as at 24.

The primary spine section extends in a first dimension and has an upper spine end, a lower spine end, and a spine length intermediate the upper and lower spine ends. Each secondary anterior marketing channel construction 22 has a channel-to-spine junction site and an upwardly extending secondary anterior channel section 28. Each upwardly extending secondary anterior channel section 28 and the primary spine section 21 together define a secondary matter-receiving channel as at 29. Each secondary matter-receiving channel 29 has an open upper secondary channel end 30.

The posterior device-to-channel tuck-in construction 23 has a tuck-to-spine junction site and a downwardly extending tuck-in section 33. The downwardly extending tuck-in section 33 and the primary spine section 21 together define a tertiary matter-receiving channel as at 34, which tertiary matter-receiving channel 34 has an open lower channel end as at 35. The tuck-in section 33 has a select tuck-in length.

The posterior securing tab 24 has a tab-to-spine junction site and a select tab length, which select tab length extends posteriorly relative to the primary spine section 21. The expander construction of the device 10 is attachable to a primary price channel construction 11 for expanding the marketing potential therefor, and the posterior securing tab 24 prevents upward movement of the expander construction relative to the primary price channel construction when attached thereto.

The select tab length of the fixed transverse cross-sectional expander profile may be preferably selected from a tab length range, which tab length range preferably ranges from 0.125 inches (0.31750 cm) to 0.625 inches (1.5875 cm). Further, the select tuck-in length of the fixed transverse cross-sectional expander profile may be preferably selected from a tuck-in length range, which tuck-in length range preferably ranges from 0.25 inches (0.635 cm) to 2.5 inches (6.35 cm).

Stated another way, the present invention essentially provides a price channel marketing expander device for use with a price channel construction for expanding the marketing potential of the channel construction, the price channel marketing expander device according to the present invention may be said to basically or essentially comprise or provide an expander construction having a primary spine section, at least one secondary anterior marketing channel section, a posterior device-to-channel tuck-in section, and a posterior securing tab.

The primary spine section extends in a first dimension, and each secondary anterior marketing channel section and the primary spine section define a secondary matter-receiving channel. The downwardly extending tuck-in section and the primary spine section defining a tertiary matter-receiving channel. The tuck-in section has a select tuck-in length, and the posterior securing tab has a select tab length.

The select tab length extends posteriorly relative to the primary spine section. The expander construction is attachable to a price channel construction for expanding the marketing potential therefor, and the posterior securing tab basically functions to prevent upward movement of the expander construction relative to the price channel construction when attached thereto.

Accordingly, although the invention has been described by reference to a number of embodiments, it is not intended that the novel device be limited thereby, but that modifications thereof are intended to be included as falling within the broad scope and spirit of the foregoing disclosure, the following claims, and the appended drawings.

I claim:

1. A price channel marketing expander system for expanding marketing potential of a price channel construction, the price channel marketing expander system comprising, in combination:
a primary price channel construction, the primary price channel construction having a fixed transverse cross-sectional channel profile, the fixed transverse cross-sectional channel profile comprising shelf-attachment means for attaching the extruded price channel construction to a shelf unit, a downwardly extending posterior channel section, an upwardly extending primary anterior channel section, and an anterior-to-posterior channel section junction site, the posterior and primary anterior channel sections being spaced from one another via the anterior-to-posterior section junction site thereby forming a primary matter-receiving channel, the primary matter-receiving channel having a primary open upper channel end; and
an expander construction, the expander construction having a fixed transverse cross-sectional expander profile, the fixed transverse cross-sectional expander profile comprising a primary spine section, at least one anterior marketing channel construction, a posterior device-to-channel tuck-in construction, and a posterior securing tab, the primary spine section extending in a first dimension and having an upper spine end, a lower spine end, and a spine length intermediate the upper and lower spine ends, each anterior marketing channel construction having a channel-to-spine junction site and an upwardly extending second anterior channel section, the upwardly extending secondary anterior channel section and the primary spine section defining a secondary matter-receiving channel, each secondary matter-receiving channel having an open upper secondary channel end, the posterior device-to-channel tuck-in construction having a tuck-to-spine junction site and a downwardly extending tuck-in section, the downwardly extending tuck-in section and the primary spine section defining a tertiary matter-receiving channel, the tertiary matter-receiving channel having an open lower channel end, the tuck-in section having a select tuck-in length, the posterior securing tab having a tab-to-spine junction site and a select tab length, the select tab length extending orthogonally relative to the primary spine section in a second dimension;
the expander construction being attachable to the primary price channel construction by simultaneously inserting (1) the downwardly extending tuck-in section into the primary matter-receiving channel, and (2) the upwardly extending primary anterior channel section into the tertiary matter-receiving channel, the posterior securing tab extending in inferior adjacency to the anterior-to-posterior channel section junction site for preventing upward movement of the expander construction relative to the primary price channel construction.

2. The price channel marketing expander system of claim 1 wherein the select tab length of the fixed transverse cross-sectional expander profile is selected from a tab length range, the tab length range ranging from 0.125 inches to 0.625 inches.

3. The price channel marketing expander system of claim 1 wherein the select tuck-in length of the fixed transverse cross-sectional expander profile is selected from a tuck-in length range, the tuck-in length range ranging from 0.25 inches to 2.5 inches.

4. The price channel marketing expander system of claim 1 wherein the fixed transverse cross-sectional expander profile comprises at least one upper anterior marketing channel construction and a lowermost anterior marketing channel construction.

5. The price channel marketing expander system of claim 4 wherein the lowermost anterior marketing channel construction extends from the primary spine section with an arcuate radius of curvature at its channel-to-spine junction site and each upper anterior marketing channel construction extends from the primary spine section orthogonally in the second dimension at the respective channel-to-spine junction site(s).

6. The price channel marketing expander system of claim 1 wherein the posterior device-to-channel tuck-in construction extends from the primary spine section orthogonally in the second dimension at the tuck-to-spine junction site.

7. The price channel marketing expander system of claim 4 wherein the fixed transverse cross-sectional expander profile comprises an uppermost anterior marketing channel construction and a channel lid section, the channel lid section extending anteriorly from the primary spine section in the second dimension for covering the open upper channel end of the uppermost anterior marketing channel construction.

8. The price channel marketing expander system of claim 7 wherein the channel lid section extends orthogonally relative to the primary spine section in the second and is coextensive with the device-to-channel tuck-in construction at the tuck-to-spine junction site.

9. A price channel marketing expander device for use with a price channel construction for expanding marketing potential therefor, the price channel marketing expander device comprising:
an expander construction, the expander construction comprising a primary spine section, at least one secondary anterior marketing channel construction, a posterior device-to-channel tuck-in construction, and a posterior securing tab, each secondary anterior marketing channel construction having a channel-to-spine junction site and an upwardly extending secondary anterior channel section, each upwardly extending secondary anterior channel section and the primary spine section defining a secondary matter-receiving channel, each secondary matter-receiving channel having an open upper secondary channel end, the posterior device-to-channel tuck-in construction having a tuck-to-spine junction site and a downwardly extending tuck-in section, the downwardly extending tuck-in section and the primary spine section defining a tertiary matter-receiving channel, the tertiary matter-receiving channel having an open lower channel end, the tuck-in section having a select tuck-in length, the posterior securing tab having a tab-to-spine junction site and a select tab length, the select tab length extending posteriorly relative to the primary spine section, the expander construction being attachable to a primary price channel construction, the posterior securing tab for preventing upward movement of the expander construction relative to the primary price channel construction when attached thereto.

10. The price channel marketing expander device of claim 9 wherein the select tab length is selected from a tab length range, the tab length range ranging from 0.125 inches to 0.625 inches.

11. The price channel marketing expander device of claim 9 wherein the select tuck-in length is selected from a tuck-in length range, the tuck-in length range ranging from 0.25 inches to 2.5 inches.

12. The price channel marketing expander device of claim 9 comprising at least one upper anterior marketing channel construction and a lowermost anterior marketing channel construction.

13. The price channel marketing expander device of claim 12 wherein the lowermost anterior marketing channel construction extends from the primary spine section with an arcuate radius of curvature at its channel-to-spine junction site and each upper anterior marketing channel construction extends from the primary spine section orthogonally at the respective channel-to-spine junction site(s).

14. The price channel marketing expander device of claim 9 wherein the posterior device-to-channel tuck-in construction extends from the primary spine section orthogonally at the tuck-to-spine junction site.

15. The price channel marketing expander device of claim 9 comprising an uppermost anterior marketing channel construction and a channel lid section, the channel lid section extending anteriorly from the primary spine section for covering the open upper channel end of the uppermost anterior marketing channel construction.

16. The price channel marketing expander device of claim 15 wherein the channel lid section extends orthogonally relative to the primary spine section and is coextensive with the device-to-channel tuck-in construction at the tuck-to-spine junction site.

17. A price channel marketing expander device, the price channel marketing expander device comprising:
a spine section, at least one secondary marketing channel section, a device-to-channel tuck-in section, and a securing tab, each secondary marketing channel section and the spine section defining a first matter-receiving channel, the tuck-in section and the spine section defining a second matter-receiving channel, the device-to-channel tuck-in section being attachable to a price channel construction, the securing tab extending in inferior adjacency to the price channel construction for preventing upward movement of the expander device relative to the price channel construction when attached thereto.

18. The price channel marketing expander device of claim 17 wherein the securing tab comprises a select tab length, the select tab length being selected from a tab length range, the tab length range ranging from 0.125 inches to 0.625 inches.

19. The price channel marketing expander device of claim 17 wherein the device-to-channel tuck-in section comprises a select tuck-in length, the select tuck-in length being selected from a tuck-in length range, the tuck-in length range ranging from 0.25 inches to 2.5 inches.

20. The price channel marketing expander device of claim 17 comprising a plurality of anterior marketing channel sections.
